(19) United States
(12) Patent Application Publication
(10) Pub. No.: US 2025/0105526 A1
(43) Pub. Date: Mar. 27, 2025

(54) PASSIVE REFLECTOR FOR REFLECTING A RADIO SIGNAL

(71) Applicant: TECHNISCHE UNIVERSITÄT DORTMUND, Dortmund (DE)

(72) Inventors: Christian WIETFELD, Dortmund (DE); Stefan BÖCKER, Dortmund (DE)

(21) Appl. No.: 18/728,702

(22) PCT Filed: Jan. 12, 2023
(86) PCT No.: PCT/EP2023/050657

§ 371 Date: Jul. 12, 2024

(30) Foreign Application Priority Data
Jan. 13, 2022 (DE) 102022100772.3

(51) Int. Cl. H01Q 15/14; H01Q 19/18; H04B 7/145

(52) U.S. Cl. CPC H01Q 15/144; H01Q 19/18; H04B 7/145

(57) ABSTRACT

A passive reflector for reflecting a radio signal is configured as a flat element with a structured surface, the surface including an electrically conductive material, and the surface being structured in such a way that the surface includes a plurality of reflective surfaces, each of which reflects the radio signal incident from a first direction in a second direction different from the first direction, the respective second direction in which the radio signal is reflected being different for at least two reflective surfaces. In this way, it is possible to provide a device for reflecting a radio signal which functions without an additional power supply and can be integrated into a cityscape.

The invention relates to a passive reflector for reflecting a radio signal in a radio network.

Conventional radio networks, such as mobile phone networks, use, among other things, electronically trackable antennas which, with the help of beam-forming technology, are able to dynamically align the main beam direction of an antenna on the basis of so-called phased arrays in such a way that needs-based radio coverage is provided at the location of a mobile end device. Within an area to be supplied with a radio signal, various interference factors, such as tall buildings or trees, often result in areas with poor radio coverage in which no radio signal or the radio signal can only be poorly received.

In order to be able to reliably cover these areas with poor radio coverage, additional antennas or repeaters are usually used to receive, amplify and retransmit the radio signal. However, this approach comprises the disadvantage that the additional components, such as antennas or repeaters, require their own power supply, making network planning more complex, as care must be taken to ensure a sufficient power supply when positioning the antennas or repeaters. Due to their size and visual appearance, they are also difficult to integrate into an urban landscape, meaning that additional antennas or repeaters not only make network planning more complex, but are also perceived as a nuisance. It is not uncommon for residents living in the immediate vicinity of a planned or existing antenna system to lodge a complaint for fear of health problems due to the radiation or in order not to spoil an attractive cityscape.

The devices known from the state of the art do not yet make it possible to provide a device for extending a radio network that can be integrated into a radio network in a particularly simple manner.

Based on this, it is an objective technical problem of the invention to provide a device for increasing the range of a radio signal, in particular for forwarding a radio signal via non-direct line-of-sight connections, which functions without an additional power supply and can be integrated into a cityscape in an acceptable manner.

This problem is solved by the object of patent claim 1. Preferred further embodiments can be found in the sub-claims.

According to the invention, a passive reflector for reflecting a radio signal is thus provided, wherein the passive reflector is configured as a flat element with a structured surface, the surface comprises an electrically conductive material and the surface is structured in such a way that the surface comprises a plurality of reflective surfaces which each reflect the radio signal incident from a first direction in a second direction different from the first direction, wherein the respective second direction in which the radio signal is reflected is different for at least two reflective surfaces.

In this case, “passive” means that the radio signal is not actively manipulated. The reflector therefore functions without actively transmitting the radio signal. Accordingly, the passive reflector does not include any components that require a power supply. It functions without being connected to a wired communication or power network.

In this case, “flat” means that the reflector is plate-like and, in contrast to a cylindrical rod antenna, comprises large, at least approximately flat or only slightly curved surfaces relative to the overall shape of the reflector. This results in very low installation depths when installed. According to the law of reflection, passive reflectors must be customized with regard to the expected angle of incidence and the desired angle of reflection on the basis of the network planning. Preferably, the normal vector of the flat reflector surface lies exactly between the angle of the incident radio signal and the angle of the reflected radio signal.

When the term “electrically conductive material” is used here, it refers to a material that comprises sufficient electrical conductivity for the application in question.

The term “reflective surfaces” refers to individual modules that are lined up or put together in pieces to form the passive reflector. In particular, the higher the number of modules N used, the lower the material consumption, as the total volume of the reflector is proportional to 1/N². The angle of reflection can be adjusted in particular via the inclination of the reflective surfaces and/or in the elevation. Preferably, the azimuth and/or elevation reflection properties are adjusted via the inclination of the reflective surfaces in the horizontal and/or vertical direction.

It is therefore an essential point of the invention that the reflector can reflect the radio signal without the radio signal comprising to be actively manipulated due to the flat electrically conductive surface, so that no components requiring a power supply are required. This means that the possible positions of the passive reflector can be selected regardless of a power supply. The passive reflector can therefore be installed and integrated into a radio network particularly easily without adapting the network operation and can be manufactured in a material- and cost-efficient manner.

According to a preferred further development of the invention, the electrically conductive material comprises an electrically conductive coating. The electrically conductive coating makes it possible to produce a material suitable for the passive reflector from any non-conductive material by applying an electrically conductive coating to the non-conductive material in order to produce metal-like reflective properties. In this way, the reflector can be manufactured from an inexpensive plastic, for example, and then coated with an electrically conductive coating. Preferably, the reflector comprises a 3D print made from a non-conductive material that is individually produced using a 3D printer. The non-conductive material preferably comprises a material with a low filling density so that the material costs can be minimized. Preferably, the electrically conductive coating comprises spraying, electroplating or painting with an electrically conductive material. A particularly suitable electrically conductive coating is one that is also used to improve the shielding of housings, such as MG Chemicals 841 Super Shield Nickel or 843AR Super Shield Silver Coated Copper.

According to a preferred further development of the invention, the passive reflector is configured as a single piece. “Single piece” in the present case means that the passive reflector is manufactured in one piece. Preferably, the single piece production is carried out by means of 3D printing processes or as part of the 3D building printing process, in which facade forms that are to be used as passive reflectors are integrated directly into the facade print of the building. Several passive reflectors can be combined to increase the surface area.

According to a preferred further development of the invention, the structured surface comprises a honeycomb-like arrangement of several semi-cavity moulds. “Honeycomb-like” in the present case means that the individual semi-cavity moulds are arranged next to each other and preferably directly adjacent to each other in several rows in the manner of a honeycomb, and that several rows are preferably arranged offset to each other. The term “semi-cavity moulds” refers in particular to flexible surface shapes that can comprise different base areas and are symmetrical or asymmetrical. Depending on the area of application and the desired reflective properties, the semi-cavity moulds can be semi-cavity spheres, semi-cavity pyramids, semi-cavity cubes or other semi-cavity bodies with different base surfaces. The base surfaces can differ in length, width and/or radius so that a variety of different design options for the semi-cavity moulds can be combined. The different semi-cavity shapes can be arranged heterogeneously or homogeneously distributed. If one considers a planar electromagnetic wave that impinges on any reflective surface, diffuse reflection can be achieved if the surface is not flat. In particular, a section of a circle embedded in the reflector produces a uniformly distributed reflection beam.

According to a preferred further development of the invention, the reflective surfaces comprise a reflective side facing the ground when in use and a non-reflective side facing away from the ground when in use. Consequently, the surface comprises a plurality of reflective surfaces which protrude at least partially from the surface and, when the passive reflector is arranged vertically, each comprise a side which points upwards, i.e. away from the ground, and each comprise a side which points downwards, i.e. towards the ground. The side facing the ground is then specifically controlled by the electrically trackable antenna to reflect the radio signal, while the side facing away from the ground can be configured for other purposes. According to a preferred further development of the invention, the non-reflective side facing away from the ground when in use comprises photovoltaic elements and/or planted elements. In this way, the surfaces not used for reflection can be used for an additional function. Particularly in heavily built-up urban areas, where there are many areas with inadequate radio coverage, the non-reflective surfaces of the passive reflector can be used for urban vertical gardens or for generating renewable energy.

According to a preferred further development of the invention, the flat element comprises a heat-insulating material. With a heat-insulating material, it is achieved that the passive reflector can take on a further additional function. Thus, the passive reflector can serve as protection against heat loss for the surface on which it is arranged.

According to the invention, the use of a passive reflector described above is provided for extending the coverage of a radio network. The passive reflectors are integrated into a radio network and can be specifically controlled by a base antenna or base station. The radio signal is then reflected into an area that is insufficiently covered by radio technology, so that the radio network is extended into this area.

Furthermore, according to the invention, the use of a passive reflector described above as a facade element for cladding a building is envisaged. The passive reflector can be configured as a facade element in such a way that it can be immersively integrated into the sur15 roundings. If a building is clad with passive reflectors, it is possible to extend the radio network and still use unobtrusive components that are not perceived as disruptive. The passive reflectors can be integrated inconspicuously into a cityscape.

According to the invention, a method for producing a passive reflector for a radio network as described above is provided, comprising the following method steps:
Determining a radio network coverage of a radio signal transmitted by a trackable antenna based on a model of an area to be supplied with the radio signal,
Determining at least one partial area in the model of the area to be supplied in which the transmitted radio signal cannot be received,
Determining a position of the passive reflector in the model of the area to be supplied, whereby the position is selected in such a way that the trackable antenna can specifically control the passive reflector and the passive reflector can reflect the radio signal transmitted by the trackable antenna,
Determining a surface structure of the passive reflector, whereby the surface structure is selected in such a way that the radio signal transmitted by the trackable antenna is reflected into the determined partial area,
Fabricating of the passive reflector based on the determined surface structure and
Installing the passive reflector in the area to be supplied based on the determined position.

Conventional network planning involves creating a three-dimensional model of an area to be supplied with a radio signal. The three-dimensional model primarily includes surrounding buildings and their external structures as well as trees. Taking into account specified coverage targets and potential locations for the base antenna and the antenna properties, the radio network propagation in the area to be covered is modelled using a network planning algorithm. The result is a digital model of the radio network coverage without passive reflectors. On the basis of the digital model, potential positions of the passive reflector and an optimum surface structure are now determined, which make it possible to reflect the radio signal into the sub-areas with insufficient radio signal coverage. The influence of the passive reflectors on the radio network can be modelled in the three-dimensional digital model. If the result is satisfactory, the passive reflector is manufactured according to the determined properties and installed at the corresponding position. When manufacturing the passive reflector, the individual modules or reflective surfaces are produced first and installed individually at the corresponding position in the form of tiles. Preferably, the conductive coating is applied after the passive reflector comprises been installed.

The production of the passive reflector includes, in particular, the production of the flat base element with a structured surface, for example using 3D printing, and the subsequent coating or painting or spraying of the surface.

In the following, the invention is explained in further detail with reference to the drawings by means of a preferred embodiment example.

In the figures show

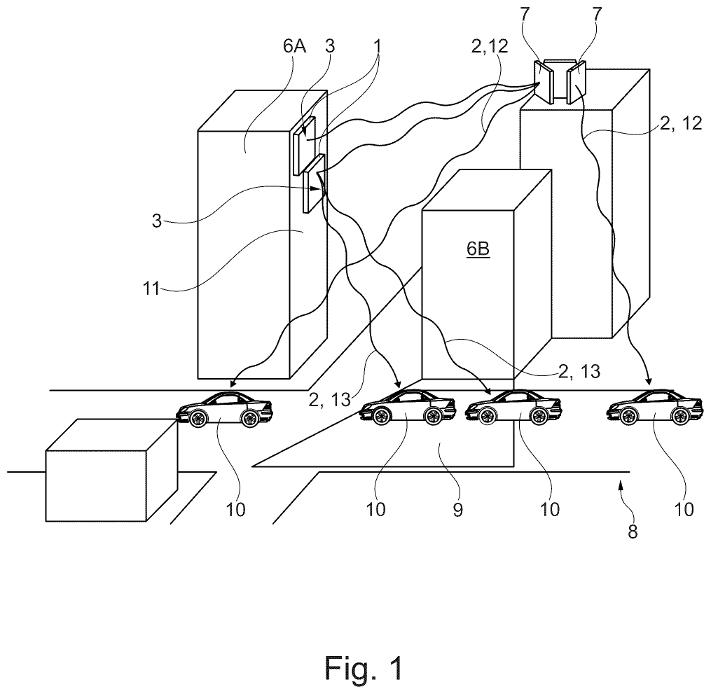

FIG. 1 schematically an area to be supplied with a passive reflector according to a preferred embodiment of the invention,

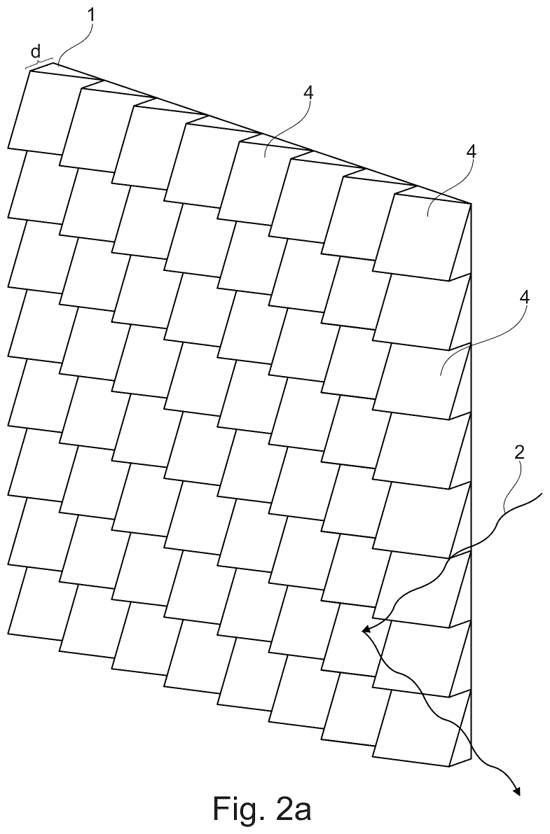

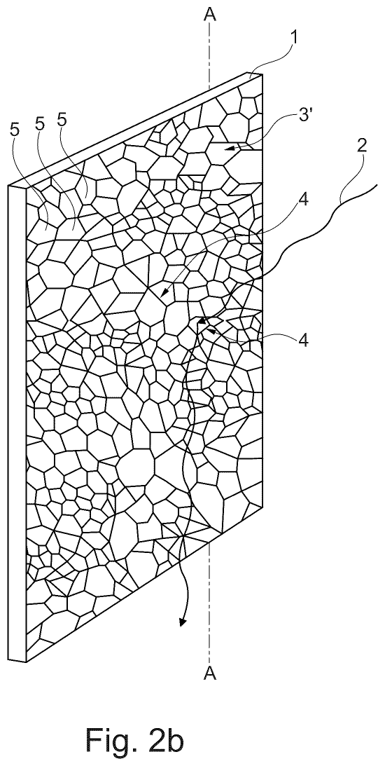

FIG. 2a schematically a perspective view of a passive reflector according to a preferred embodiment of the invention,

FIG. 2b schematically a perspective view of a passive reflector according to a further preferred embodiment of the invention,

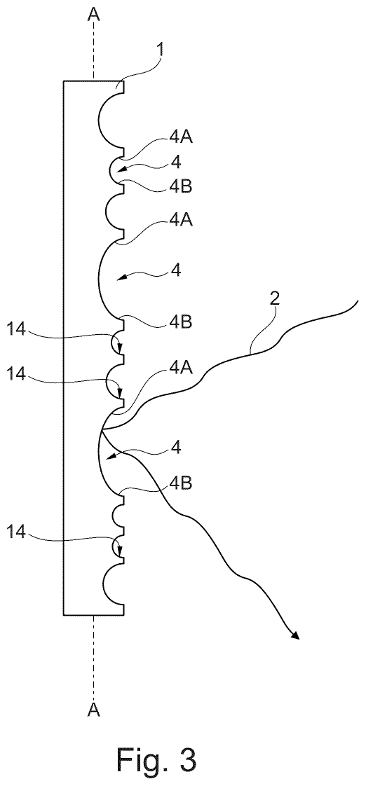

FIG. 3 schematically a sectional view of a passive reflector according to a preferred embodiment of the invention,

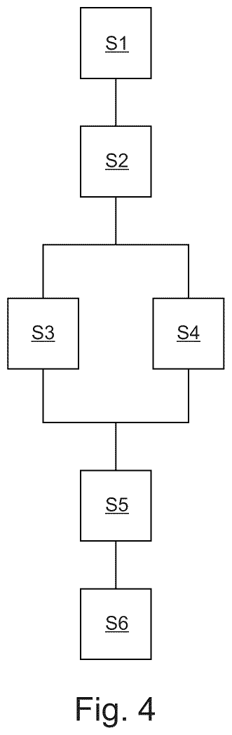

FIG. 4 schematically a method for manufacturing a passive reflector according to a preferred embodiment of the invention.

FIG. 1 schematically shows an area 8 to be supplied with a passive reflector 1. The area 8 to be covered comprises a trackable antenna 7 that transmits a radio signal 2. In the shadow of the building 6B, a partial area 9 is created in which the radio signal 2 can only be received poorly or not at all by the mobile receivers 10. To ensure that the radio signal 2 can still be received, two passive reflectors 1 are arranged on a facade 11 of a adjacent building 6A. The radio signal 2 is transmitted specifically to the passive reflectors 1 and reflected into the sub-area 9 without being actively manipulated. Outside the sub-area 9, the radio signal 2 is received via a direct connection 12 between antenna 7 and mobile receiver 10. Inside the sub-area 9, the radio signal 2 is received by the mobile receivers 10 via the connection between antenna 7 and mobile terminal 10 via the reflection on the passive reflector 13. The position of the passive reflector 1 and the surface 3 of the passive reflector 1 are selected in such a way that the radio signal 2 is reflected into the sub-area 9. The passive reflector 1 is used as a facade element for cladding the facade 11 of the building 6A. It is configured to harmonize with the cityscape so that it can be immersively integrated into a cityscape.

FIG. 2a and FIG. 2b each show a passive reflector 1 in a perspective view. The passive reflector 1 in FIG. 2a consists of a series of individual modules, the so-called reflective surfaces 4. The reflective surfaces can be either planar—as shown in FIG. 2a—or curved. The incident radio signal 2 is reflected at the reflective surfaces 4. The normal vector of the reflective surface 4 lies exactly between the angle of the incident radio signal and the angle of the reflected radio signal. Both the azimuth and elevation reflection properties are adjusted via the inclination of the reflective surfaces 4 in both the vertical and horizontal directions. This modular approach makes it possible for the depth d of the passive reflector 1 to decrease with the number of modules N, so that an unobtrusive installation is possible.

The passive reflector 1 in FIG. 2b comprises a structured surface 3′. The structure is created by lining up several semi-cavity moulds 5. In this specific example, the semi-cavity moulds 5 are distributed heterogeneously. This means that the semi-cavity moulds 5 comprise different base surfaces. They can be angular or round and are not arranged in a regular pattern. The structured surface 3′ comprises a number of reflective surfaces 4 on which the radio signal 2 is reflected. The radio signal 2 is reflected in a different direction than it is incident. The structured surface 3′ is electrically conductive. The electrical conductivity is created either by selecting an electrically conductive material from which the passive reflector 1 is made or by coating a non-electrically conductive material with an electrically conductive coating.

FIG. 3 shows a passive reflector 1 in a sectional view along the sectional axis A-A of a similar passive reflector 1 from FIG. 2. The reflective surfaces 4 are recognizable in the sectional view. The reflective surfaces 4 comprise two sides. One side 4A is reflective and faces the ground in the vertical arrangement of the reflector 1. The other side 4B is non-reflective and faces away from the ground in the vertical arrangement of the reflector 1. The passive reflector 1 is positioned in the area 8 to be covered in such a way that the radio signal 2 hits the reflective side 4A and is reflected. The non-reflective side 4B, which is not used for reflection, is used for other purposes. By arranging photovoltaic elements or planted elements 14, the area not used for reflection can be used for energy generation or to provide urban gardens.

FIG. 4 shows a method for manufacturing a passive reflector 1 according to a preferred embodiment of the invention. In a first step S1, the radio network coverage of a radio signal 2 transmitted by a trackable antenna 7 is determined. The determination of the radio network coverage is based on a model of the area 8 to be covered. The radio propagation is modelled so that, in a next step S2, partial areas 9 can be determined in which the radio signal 2 can be received poorly or not at all.

Based on the model and the determined partial areas 9, a possible position of the passive reflector 1 in the model and a surface structure 3′ dependent on it are determined S3, S4.

Based on the determined position and the surface structure 3′, the passive reflector 1 is manufactured S5 and installed in the real environment S6.

### LIST OF REFERENCE SYMBOLS

1 Passive reflector
2 Radio signal
3 Surface
3′ Surface structure
4 Reflective surfaces
4A Reflective side facing the ground
4B Non-reflective side facing away from the ground
5 Semi hollow mould
6A Building
6B Building
7 Trackable antenna
8 Area to be supplied
9 Sub-area with insufficient coverage
10 Mobile receiver
11 Building facade
12 Direct radio signal connection
13 Radio signal connection via passive reflector
14 Planted elements
A-A Sectional axis
d Depth
S1 Determine radio network coverage
S2 Determining at least a partial range in which the transmitted radio signal cannot be received
S3 Determining a position of the passive reflector
S4 Determining a surface structure of the passive reflector
S5 Fabricating the passive reflector
S6 Installing the passive reflector

1. A passive reflector for reflecting a radio signal, wherein:
the passive reflector is configured as a flat element with a structured surface,
the surface comprises an electrically conductive material, and
the surface is structured in such a way that the surface comprises a plurality of reflective surfaces, each of which reflects the radio signal incident from a first direction in a second direction different from the first direction, the respective second direction in which the radio signal is reflected being different for at least two reflective surfaces.

2. The passive reflector according to claim 1, wherein the electrically conductive material comprises an electrically conductive coating.

3. The passive reflector according to claim 1, wherein the passive reflector is formed in one piece.

4. The passive reflector according to claim 1, wherein the structured surface comprises a honeycomb-like arrangement of a plurality of semi-cavity moulds.

5. The passive reflector according to claim 1, wherein the reflective surfaces comprise a reflective side facing the ground in use and a non-reflective side facing away from the ground in use.

6. The passive reflector according to claim 5, wherein the non-reflective side facing away from the ground in use comprises photovoltaic elements and/or planted elements.

7. The passive reflector according to claim 1, wherein the planar element comprises a thermally insulating material.

8. A method of using a passive reflector according to claim 1 for extending the coverage of a radio network.

9. A method of using a passive reflector according to claim 1 as a facade element for cladding a building.

10. A method of manufacturing the passive reflector according to claim 1 for a radio network, comprising the following method steps:
determining a radio network coverage of a radio signal transmitted by a trackable antenna based on a model of an area to be supplied with the radio signal,
determining at least one partial area in the model of the area to be supplied, in which the transmitted radio signal cannot be received,
determining a position of the passive reflector in the model of the area to be supplied, the position being selected in such a way that the trackable antenna can specifically control the passive reflector and the passive reflector can reflect the radio signal transmitted by the trackable antenna,
determining a surface structure of the passive reflector, wherein the surface structure is selected in such a way that the radio signal transmitted by the trackable antenna is reflected into the determined sub-region,
fabricating of the passive reflector based on the determined surface structure, and
installing the passive reflector in the area to be supplied based on the determined position.
